(19) United States
(12) Patent Application Publication
(10) Pub. No.: US 2018/0209654 A1
(43) Pub. Date: Jul. 26, 2018

(54) COMBUSTION CHAMBER OF A GAS TURBINE, GAS TURBINE AND METHOD FOR OPERATING THE SAME

(71) Applicant: MAN DIESEL & TURBO SE, Augsburg (DE)

(72) Inventors: Frank REISS, Lauchringen (DE); Bernhard COSIC, Duesseldorf (DE)

(21) Appl. No.: 15/876,912

(22) Filed: Jan. 22, 2018

(30) Foreign Application Priority Data
Jan. 23, 2017 (DE) 10 2017 101 167.6

(51) Int. Cl. F23R 3/36; F23R 3/12; F02C 9/40; F23R 3/28

(52) U.S. Cl. CPC F23R 3/36; F23R 3/12; F23R 3/283; F05D 2240/35; F02C 9/40

(57) ABSTRACT

A combustion chamber assembly of a gas turbine, for combusting a fuel in the presence of combustion air, is configured as a dual-fuel combustion chamber assembly. In a gas fuel operating mode a mixture of a gaseous fuel and combustion air is supplied to the combustion chamber via a swirl body. In a liquid fuel operating mode liquid fuel is fed to the combustion chamber via a fuel lance and combustion air is fed to the combustion chamber via the swirl body. The fuel lance is surrounded by an adjoining lance cap to form a radial clearance therebetween such that the combustion chamber is feedable with combustion air via the radial clearance, bypassing the swirl body.

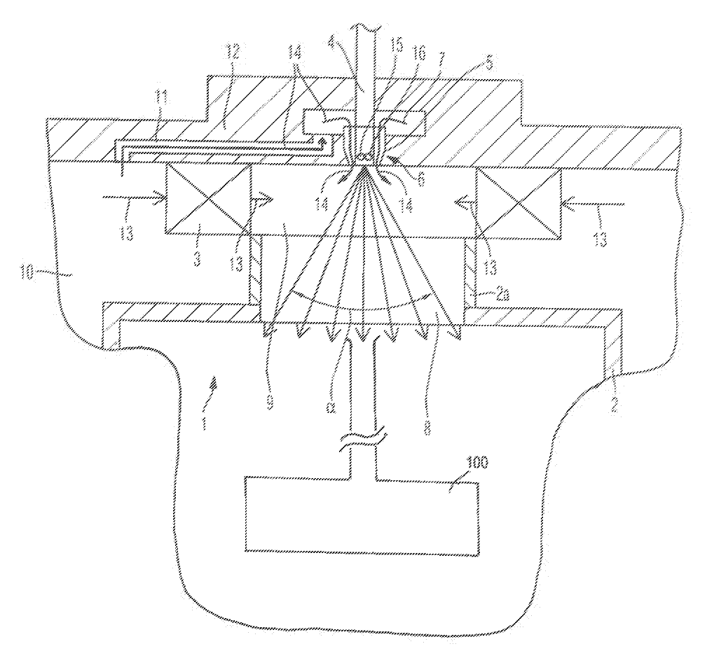

### BACKGROUND OF THE INVENTION

### 1. Field of the Invention

The invention relates to a combustion chamber assembly, having a combination chamber, of a gas turbine and to a gas turbine with such a combustion chamber assembly, and to a method for operating such a gas turbine.

### 2. Description of the Related Art

Gas turbines include a combustion chamber and a turbine arranged downstream of the combustion chamber. In the combustion chamber of a gas turbine, a fuel is combusted and hot exhaust gas generated in the process. The hot exhaust gas is expanded in the turbine of the gas turbine in order to thereby extract energy, which can be used to provide drive power, in order to, for example drive a generator that generates electric current. Gas turbines configured as dual-fuel gas turbines are known. Such dual-fuel gas turbines include a dual-fuel combustion chamber, in which in a gas fuel operating mode a gaseous fuel, and in a liquid fuel operating mode a liquid fuel, are combusted. In the gas-fuel operating mode, a mixture of a gaseous fuel, and combustion air can be fed to the combustion chamber via a diffuser. In the liquid fuel operating mode, the liquid fuel can be fed to the combustion chamber of the gas turbine via a fuel lance and the combustion air via the swirl body.

There is a need for further improving combustion chambers of a gas turbine designed as dual-fuel combustion chambers so that, in particular, in the liquid fuel operating mode the liquid fuel can be more effectively combusted, namely subject to reducing undesirable exhaust gas emissions such as nitrogen oxide emissions.

### SUMMARY OF THE INVENTION

In view of the foregoing, it is an object of the present invention to create a new type of combustion chamber assembly, including a combustion chamber, of a gas turbine, a gas turbine with such a combustion chamber assembly and a method for operating such a gas turbine.

This object may be achieved, according to one aspect of the present invention, by providing a combustion chamber assembly of a gas turbine in which, a fuel lance is, at least in sections, surrounded by an adjoining lance cap radially on the outside subject to forming a radial clearance, wherein combustion air bypassing a swirl body can be fed to a combustion chamber of the assembly via the radial clearance. With the feeding of the combustion air to the combustion chamber via the radial clearance formed between the fuel lance and the adjoining lance cap, the fuel lance can be cooled. In the liquid fuel operating mode, this air, furthermore, surrounds an atomization cone of the liquid fuel generated on the fuel lance on the outside, at least in sections. Finally, liquid fuel can be more effectively combusted in the liquid fuel operating mode subject to reducing exhaust gas emissions such as nitrogen oxide emissions.

According to a further development of the invention, the combustion airflow, which can be fed to the combustion chamber subject to bypassing the swirl body via the radial clearance between the fuel lance and the adjoining lance cap, amounts to between 1% and 10% of the combustion airflow, which can be fed to the combustion chamber via the swirl body. In particular when the combustion airflow conducted via the radial clearance amounts to 1% to 10% of the combustion airflow conducted via the swirl body, an effective combustion of the respective fuel subject to the reduction of in particular nitrogen oxide emissions can be ensured in the liquid fuel operating mode, on the one hand, and also in the gas fuel operating mode, on the other hand. As already explained above, the fuel lance is cooled in the liquid fuel operating mode while the airflow conducted via the radial clearance, furthermore, surrounds the atomization cone at least in sections, thus focusing the same.

According to a further development of the invention, combustion air can be fed to the combustion chamber both in the gas fuel operating mode and also in the liquid fuel operating mode via the radial clearance between the fuel lance and the adjoining lance cap. In both operating modes, an optimal combustion of the respective fuel can be ensured via the combustion air, which can be fed to the combustion chamber via the radial clearance.

According to a further development of the invention, the fuel lance comprises at least one, and preferably two, atomization nozzles which can be activated dependent on the load of the gas turbine and which by themselves and jointly each provide an atomization cone with a maximum spray angle of 60°. Forming such a maximum spray angle is also advantageous for an effective combustion of the liquid fuel in the liquid fuel operating mode while reducing in particular nitrogen oxide emissions.

### BRIEF DESCRIPTION OF THE DRAWING

Preferred further developments of the invention are obtained from the claims and the following description. Exemplary embodiments of the invention are explained in more detail by way of the single FIGURE without being restricted to this.

The FIGURE shows a highly schematic extract from a combustion chamber assembly of a gas turbine according to the invention.

### DETAILED DESCRIPTION OF THE PRESENTLY PREFERRED EMBODIMENTS

The FIGURE shows a schematic extract from a gas turbine in the region of a combustion chamber 1. The combustion chamber 1 is delimited by a wall 2, wherein in the combustion chamber 1 a fuel is combusted. Exhaust gas generated during the combustion of the fuel in the combustion chamber 1 can be fed to a turbine 100 of the gas turbine in order to expand the exhaust gas in the turbine 100 and extract energy in the process.

The combustion chamber 1 is configured as a part of a dual-fuel combustion chamber assembly, which, on the one hand, can be operated in a gas fuel operating mode and, on the other hand, can be operated in a liquid fuel operating mode. In the gas fuel operating mode of the combustion chamber assembly, a gaseous fuel is combusted in the combustion chamber 1, and a mixture of the gaseous fuel and combustion air is fed to the combustion chamber 1, in the FIGURE to a mixing chamber 9 adjacent the combustion chamber 1, via a swirl body 3. The swirl body 3 is preferentially embodied as radial swirl body and generates a defined swirl of the mixture of combustion air and gaseous fuel entering the mixing chamber 9 adjacent the combustion chamber 1. The mixture of the gaseous fuel and the combustion air is ignited in the gas fuel operating mode using an electric ignition device, which is not shown.

In the liquid fuel operating mode of the combustion chamber assembly, a liquid fuel is combusted in the combustion chamber 1, and the liquid fuel is fed to the combustion chamber 1, in the FIGURE, via the mixing chamber 9, with the help of a fuel lance 4. The fuel lance 4 sits approximately in the middle of the mixing chamber 9 and injects the liquid fuel in an axial direction, atomizing the liquid fuel and forming an atomization cone or spray cone 8, into the mixing chamber 9. In the liquid fuel operating mode, combustion air needed for combusting the liquid fuel is again fed in via the swirl body 3 of the mixing chamber 9, namely again forming a defined swirl flow. In the liquid fuel operating mode, the electric ignition device, which is not shown, can also be utilized if required.

Between the fuel lance 4, which is received in an assembly wall 12, an adjoining lance cap 5, which is likewise received in the assembly wall 12, follows the fuel lance 4 radially on the outside and, at least in sections, surrounds the fuel lance 4 radially on the outside, a radial clearance 6 is formed via which combustion air can be additionally fed to the combustion chamber 1, namely via the mixing chamber 9, bypassing the swirl body 3.

In the FIGURE, which shows the combustion chamber assembly having the combustion chamber 1 in the liquid fuel operating mode, the atomization cone 8 of the atomized liquid fuel formed by the fuel lance 4 is shown. The combustion air, which is fed to the mixing chamber 9 via the swirl body 3 is visualized by arrows 13 in the FIGURE. The combustion air, which can be fed to the mixing chamber 9 via the radial clearance 6 between the fuel lance 4 and the adjoining lance cap 5, bypassing the swirl body 3, is marked by arrows 14 in the FIGURE.

In a preferred embodiment, the lance cap 5 radially adjoining the fuel lance 4, which together with the fuel lance 4 defines the radial clearance 6, is configured as sleeve, which, via webs, is connected to the fuel lance 4. It is also possible that the assembly wall 12 itself provides the lance cap 5 adjoining the fuel lance 4 radially on the outside, which defines the radial clearance 6 together with the fuel lance 4.

The combustion air 14, which can be fed to the combustion chamber 1, via the mixing chamber 9, bypassing the swirl body 3 via the radial clearance 6 between the fuel lance 4 and the adjoining lance cap 5, amounts to between 1% and 10% of the combustion air that can be fed ultimately to the combustion chamber 1, in the FIGURE to the mixing chamber 9, via the swirl body 3.

The airflow 14, which is conducted via the radial clearance 6 or local bores, cools the fuel lance 4 on the one hand while, on the other hand, the same at least partly surrounds the spray cone 8 of the liquid fuel in the liquid fuel operating mode on the outside, thus focusing the same.

By way of the radial clearance 6, the combustion airflow 14 can be fed to the combustion chamber 1, via the mixing chamber 9, in the liquid fuel operating mode. The combustion air flow can also be fed to the combustion chamber 1 by way of the radial clearance 6 in the gas fuel operating mode. In the gas fuel operating mode the fuel lance 4 is inactive so that via the same no fuel is introduced into the combustion chamber 1 via the fuel lance 4 in the gas fuel operating mode.

In the gas fuel operating mode, the gas-combustion air mixture is conducted via the swirl body 3. In the gas fuel operating mode, combustion air is also conducted via the annular clearance 6. The combustion airflow 14 conducted via the annular clearance 6 is branched off upstream of the swirl body 13 in the region of a so-called plenum 10. The FIGURE shows an airline 11, via which the air can be branched off the plenum 10, wherein the combustion air 14 branched off the plenum 10 via the airline 11 is fed to an air chamber 7 formed by the wall 12 so that combustion air 14, emanating from this air chamber 7, can be introduced into the mixing chamber 9 via the radial clearance 6 formed between the fuel lance 4 and the adjoining lance cap 5.

The fuel lance 4 comprises at least one or two atomization nozzles 15, 16. It is possible to utilize both atomization nozzles 15, 16 simultaneously or overlappingly, while it is also possible, on the other hand, to use only one of these atomization nozzles 15, 16 in each case.

Independently of how many of the atomization nozzles 15, 16 are utilized, in order to atomize and introduce the liquid fuel into the combustion chamber 1 in the liquid fuel operating mode, the maximum spray angle α of the atomization cone 8 of the liquid fuel amounts to a maximum of 60°.

In particular when the combustion chamber assembly is operated with an active fuel lance 4, i.e., in the liquid fuel operating mode, it is provided that with the gas turbine at idle and under loads that are lower than a limit value, the first atomization nozzle 15 is activated. In particular, when the load of the gas turbine is higher than the limit value, the second atomization nozzle 16 is preferentially also activated. Accordingly, one or both of the atomization nozzles 15, 16 can be activated dependent on the load of the gas turbine.

As explained above, the fuel lance 4 is orientated preferentially in the middle to the mixing chamber 9 or combustion chamber 1 and atomizes the liquid fuel in the liquid fuel operating mode into the mixing chamber 9 and combustion chamber 1, namely subject to forming an atomization cone 8, the spray angle of which amounts to a maximum of 60°.

At least in the liquid fuel operating mode and preferably also in the gas fuel operating mode, a part of the combustion air of the mixing chamber 9 is fed in via the radial clearance 6 subject to bypassing the swirl body 3, wherein the radial clearance 6 is formed between the fuel lance 4 and an adjoining lance cap, in particular a sleeve surrounding the fuel lance 4 radially outside at least in sections. With this airflow 14 conducted via the radial clearance 6, the fuel lance 4 is cooled, on the one hand, while, on the other hand, the atomization cone 8 is focused in the liquid fuel operating mode. By way of the airflow 14 conducted via the radial clearance 6, the combustion of the now gaseous fuel can likewise be positively influenced in the gas fuel operating mode.

Because of the fact that in the liquid fuel operating mode the airflow conducted via the radial clearance 6 conducts or bundles or surrounds the spray cone 8 on the outside, liquid, atomized fuel cannot wet the wall 2 of the combustion chamber, in particular a premixing chamber 2a of the wall 2 extending between the combustion chamber 1 and the mixing chamber 9. In this manner, the premixing chamber 2a of the wall 2 of the combustion chamber 1 can be protected from damage.

Thus, while there have shown and described and pointed out fundamental novel features of the invention as applied to a preferred embodiment thereof, it will be understood that various omissions and substitutions and changes in the form and details of the device illustrated, and in its operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A combustion chamber assembly of a gas turbine, for combusting a fuel in the presence of combustion air, the combustion chamber assembly comprising:
a combustion chamber (1), in which combustion of fuel occurs, the combustion chamber (1) being delimited by a wall (2);
a mixing chamber (9) arranged upstream, in a fuel feeding direction, of the combustion chamber (1);
a fuel lance (4) configured to feed liquid fuel into the mixing chamber (9);
a lance cap (6) adjoining, and surrounding at least in sections, the fuel lance (6) so as to define a radial clearance between the fuel lance (4) and the lance cap (6); and
a swirl body (3) configured to feed combustion air and gaseous fuel to the mixing chamber (9),
wherein the combustion chamber assembly is configured as a dual-fuel combustion chamber assembly, which, in a gas fuel operating mode, feeds a mixture of a gaseous fuel and combustion air to the combustion chamber (1) via the swirl body (3), and which, in a liquid fuel operating mode, feeds liquid fuel to the combustion chamber (1) via the fuel lance (4) and combustion air to the combustion chamber (1) via the swirl body (3), and
wherein the radial clearance (6) is arranged such that combustion air is feedable to the combustion chamber (1) by bypassing the swirl body (3) via the radial clearance (6).

2. The combustion chamber assembly according to claim 1, wherein the combustion airflow fed to the combustion chamber (1) by bypassing the swirl body (3) via the radial clearance (6), amounts to between 1% and 10% of the combustion airflow that is fed to the combustion chamber (1) via the swirl body (3).

3. The combustion chamber assembly according to claim 1, wherein combustion air is feedable to the combustion chamber (1) via the radial clearance (6) both in the gas fuel operating mode and in the liquid fuel operating mode.

4. The combustion chamber assembly according to claim 1, wherein the fuel lance (4) comprises at least two atomization nozzles (15, 16) which are activatable in dependence upon the load of the gas turbine.

5. The combustion chamber assembly according to claim 1, wherein the fuel lance (4) comprises at least two atomization nozzles (15, 16) which alone and jointly in each case provide an atomization cone (8) with a maximum spray angle of 60°.

6. A gas turbine, comprising:
a combustion chamber assembly for combusting a fuel in the presence of combustion air, the combustion chamber assembly having:
a combustion chamber (1), in which combustion of fuel occurs, the combustion chamber (1) being delimited by a wall (2);
a mixing chamber (9) arranged upstream, in a fuel feeding direction, of the combustion chamber (1);
a fuel lance (4) configured to feed liquid fuel into the mixing chamber (9);
a lance cap (6) adjoining, and surrounding at least in sections, the fuel lance (6) so as to define a radial clearance between the fuel lance (4) and the lance cap (6); and
a swirl body (3) configured to feed combustion air and gaseous fuel to the mixing chamber (9),
wherein the combustion chamber assembly is configured as a dual-fuel combustion chamber assembly, which, in a gas fuel operating mode, feeds a mixture of a gaseous fuel and combustion air to the combustion chamber (1) via the swirl body (3), and which, in a liquid fuel operating mode, feeds liquid fuel to the combustion chamber (1) via the fuel lance (4) and combustion air to the combustion chamber (1) via the swirl body (3), and
wherein the radial clearance (6) is arranged such that combustion air is feedable to the combustion chamber (1) by bypassing the swirl body (3) via the radial clearance (6); and
a turbine (100) configured to expand exhaust gas created during the combustion in the combustion chamber assembly.

7. A method for operating a gas turbine including a combustion chamber assembly for combusting a fuel in the presence of combustion air, the combustion chamber assembly having: a combustion chamber (1), in which combustion of fuel occurs, the combustion chamber (1) being delimited by a wall (2); a mixing chamber (9) arranged upstream, in a fuel feeding direction, of the combustion chamber (1); a fuel lance (4) configured to feed liquid fuel into the mixing chamber (9); a lance cap (6) adjoining, and surrounding at least in sections, the fuel lance (6) so as to define a radial clearance between the fuel lance (4) and the lance cap (6); and a swirl body (3) configured to feed combustion air and gaseous fuel to the mixing chamber (9), wherein the combustion chamber assembly is configured as a dual-fuel combustion chamber assembly, which, in a gas fuel operating mode, feeds a mixture of a gaseous fuel and combustion air to the combustion chamber (1) via the swirl body (3), and which, in a liquid fuel operating mode, feeds liquid fuel to the combustion chamber (1) via the fuel lance (4) and combustion air to the combustion chamber (1) via the swirl body (3), and wherein the radial clearance (6) is arranged such that combustion air is feedable to the combustion chamber (1) by bypassing the swirl body (3) via the radial clearance (6); and a turbine (100) configured to expand exhaust gas created during the combustion in the combustion chamber assembly, the method comprising:
feeding the combustion chamber (1), in the gas fuel operating mode, a mixture of a the gaseous fuel and the combustion air via the swirl body (3);
feeding the combustion chamber (1), in the liquid fuel operating mode, the liquid fuel via the fuel lance (4) and the combustion air via the swirl body (3),
additionally feeding, in the gas fuel operating mode and in the liquid fuel operating mode, the combustion chamber (1) combustion air via the radial clearance (6) between the fuel lance (4) and the adjoining lance cap (5).

8. The method according to claim 7, wherein in the gas fuel operating mode the fuel lance (4) is inactive.

9. The method according to claim 8, wherein the fuel lance (4) comprises first and second atomization nozzles (15, 16), and wherein, in the liquid fuel operating mode, the liquid fuel is fed to the combustion chamber (1) via the fuel lance (4) such that, at idle and under loads lower than a limit value, the first atomization nozzle (15) is activated, and wherein at loads higher than a limit value, the second atomization nozzle (16) is activated.
